(19) United States
(12) Patent Application Publication
(10) Pub. No.: US 2022/0298359 A1
(43) Pub. Date: Sep. 22, 2022

(54) LIQUID COMPOSITIONS BASED ON IONIC LIQUIDS FOR THE PROTECTION OF LITHIUM METAL PARTS, ASSOCIATED COATING AND POLYMERIZATION METHODS AND ELECTROCHEMICAL STORAGE SYSTEM

(71) Applicants: SOLVIONIC, TOULOUSE (FR); National Institute of Chemistry (NIC), Ljubljana (SI)

(72) Inventors: Paolo Fantini, Vimercate (IT); Rongying Lin, Colomiers (FR); François Malbosc, FRANCE (FR); Alen Vizintin, Portoroz (SI); Cecilia Andrea Calderon, Cordoba (AR); Robert Dominko, Dol pri Ljubljani (SI)

(21) Appl. No.: 17/753,346

(22) PCT Filed: Jul. 31, 2020
(86) PCT No.: PCT/EP2020/071692

§ 371 Date: Feb. 28, 2022

(30) Foreign Application Priority Data
Aug. 30, 2019 (FR) FR1909532

(51) Int. Cl. C09D 4/06; H01M 4/134; H01M 4/1395; H01M 4/38; H01M 4/62

(52) U.S. Cl. CPC C09D 4/06; H01M 4/134; H01M 4/1395; H01M 4/382; H01M 4/62; H01M 2004/027

(57) ABSTRACT

An ionic liquid-based composition for protecting lithium metal anodes in a lithium-based electrochemical energy storage system, comprising a polymerizable ionic liquid (or ionic liquid monomer), the cation or the anion of which carries at least one polymerizable function, a non-polymerizable ionic liquid, an ionic liquid of the “crosslinker” type, the cation or the anion of which carries at least two polymerizable functions, and a lithium salt. This composition is then coated and polymerized onto a metallic lithium surface and serves as protection layer. The ionic liquid-based polymer composition coated as such on the lithium surface, even if it is swelling with liquid electrolyte, protects the lithium against a constant electrolyte consumption and formation of unstable solid-electrolyte interphase (SEI), which is continuously forming on a bare lithium surface. The growing of dendrites is retarded with such ionic liquid-based polymer composition protection.

### CROSS-REFERENCE TO RELATED APPLICATIONS

This application is a national phase entry under 35 U.S.C. § 371 of International Patent Application PCT/EP2020/071692, filed Jul. 31, 2020, designating the United States of America and published as International Patent Publication WO 2021/037479 A1 on Mar. 4, 2021, which claims the benefit under Article 8 of the Patent Cooperation Treaty to French Patent Application Serial No. FR1909532, filed Aug. 30, 2019.

### TECHNICAL FIELD

The present disclosure relates to liquid compositions based on ionic liquids for the protection of lithium metal parts, in particular, anodes in lithium electrochemical generators.

It also relates to a method of coating a metal part implementing such a composition, the subsequent polymerization of the composition, and an electrochemical storage system with anodes thus coated.

### BACKGROUND

Lithium metal is the anode material of choice for lithium batteries because of its highest theoretical capacity and lowest electrochemical potential of all candidates. However, the charging and discharging cycles of lithium metal anode batteries cause the formation of dendrites and other surface defects, which reduces battery life but can also lead to short circuits and thus serious problems of safety (thermal runaway, explosion, fire).

Due to the highly negative electrochemical potential of the Li⁺/Li redox couple, current liquid electrolytes are reduced on the surface of lithium to form a solid electrolyte interface (SEI) [1]. This passivation allows the operation of the electrochemical cell. The SEI must be an ionic conductor and an electrical insulator of homogeneous composition and morphology. It must also have good properties of flexibility and elasticity [2]. Additives are used in electrolytes. They decompose and participate in the formation of the SEI to improve the properties and therefore the performance of the electrochemical cell.

A very high concentration of lithium salt in the electrolyte can also suppress the growth of dendrites. However, this solution is very lithium salt consuming and therefore very expensive.

One of the approaches is the deposition of a protective layer on lithium before cycling (artificial SEI), by various techniques of thin film deposition.

The development and use of solid electrolytes is a mean of physically preventing the growth of dendrites. They can be organic (polymers), inorganic (ceramics) or hybrid.

European Patent EP3049471B1 discloses lithium ion conductive polymer compositions for a lithium electrochemical generator, containing at least one non-ionic polymer.

International Patent Application Publication WO2016205653A “Multi-layered polymer coated Li anode for high-density Li metal battery” discloses two layers of polymers.

U. S. Patent U.S. Pat. No. 9,627,713B2 “Composite electrolyte including polymeric ionic liquid matrix and embedded nanoparticles, and method of making the same” discloses a composite electrolyte comprising inorganic nanoparticles, hence a hybrid organic/inorganic composition. The layer is both protective of lithium and electrolyte. The battery formed does not contain liquid electrolyte.

U. S. Patent Application Publication US20160164102A1 discloses a protective coating of a metal, organic/inorganic hybrid (inorganic part=ceramic nanoparticles). The coating contains ionic liquids and is obtained by UV polymerization.

U. S. Patent U.S. Pat. No. 5,961,672B discloses a stabilized anode for lithium polymer batteries. The technique of depositing the protective film of lithium is a vacuum deposit.

WIPO Patent Application Publication WO2018/122428A1 discloses a coating composition comprising an ionic liquid and a cross-linked polymeric ionic liquid, wherein the cross-linked polymeric ionic liquid and the ionic liquid are not joined via covalent bonds, and wherein the cross-linked polymeric ionic liquid is joined to a surface of the substrate.

The object of the present disclosure is to overcome these disadvantages by providing a liquid composition to protect lithium metal, which is simpler and less costly to implement than currently available protection compositions.

### BRIEF SUMMARY

This objective is achieved with an ionic liquid-based composition for the protection of lithium metal anodes in a lithium based electrochemical energy storage system, comprising:
a polymerizable ionic liquid (or ionic liquid monomer), the cation or the anion of which carries at least one polymerizable function,
a non-polymerizable ionic liquid,
an ionic liquid of the “crosslinker” type, the cation or the anion of which carries at least two polymerizable functions,
a lithium salt, and
an ionic polymer.

Such an ionic polymer can contribute to improve the mechanical properties of the anodes.

The liquid composition according to the present disclosure may also advantageously comprise a UV or thermal polymerization initiator. This polymerization initiator is degraded during the polymerization and present in a negligible amount.

According to another aspect of the present disclosure, a method is provided for the coating of a metal piece of lithium, such as a lithium anode of an electrochemical generator, implementing a liquid protective composition obtained by deposition and polymerization of a liquid formulation of the present disclosure, comprising the steps of:
depositing a liquid solution having the composition on the metal part, and
polymerizing the liquid solution thus deposited, under the action of UV radiation or heat.

The deposition step may be performed by applying a film of the liquid solution. Or by soaking the metal part in the liquid solution.

The polymer coating thus obtained differs from the prior art in that all the components of this formulation are ionic.

According to yet another aspect of the present disclosure, there is provided a lithium based electrochemical storage system (such as lithium sulfur battery, lithium metal battery, lithium-ion battery, lithium-ion capacitor) comprising a lithium anode covered with such a deposited layer having an ionic composition according to the present disclosure.

In the present disclosure, there is only one polymer layer (between the metal Li and the electrolyte). These are only ionic based polymers and components.

The composition according to the present disclosure is only organic. It is a protective layer for lithium and this “protected” lithium can then form the anode of a battery containing a liquid electrolyte.

The coating used in the present disclosure is simply deposited, whereas in the prior art, this coating is covalently bonded to the surface of the lithium metal. All components are ionic and therefore participate in the ionic conductivity of the whole.

The protective coating thus obtained constitutes a lithium ion conductive membrane thanks to the combination of the ionic elements and the lithium salt.

This membrane is mechanically, chemically and electrochemically stable in contact with metallic lithium.

The membrane has a very good ionic conductivity (6×10⁻² mS/cm at room temperature and 4.9×10⁻¹ mS/cm at 80° C.), an order of magnitude higher than that of a membrane disclosed in European Patent EP3049471B1 (5×10⁻² mS/cm at 80° C.).

All components of the membrane are ionic, which provides good conductivity, while a neutral component is still present in other formulations of the prior art.

The protective composition according to the present disclosure can lead to many combinations of materials, in order to optimize the composition as a function of the cathode material to be chosen.

### BRIEF DESCRIPTION OF THE DRAWINGS

The figures will detail some examples of embodiments of the present disclosure, in particular:

FIG. 1 represents the coating process of the polymeric composition based on ionic liquids on the surface of a metallic lithium foil;

FIG. 2 represents the stripping and deposition tests on symmetrical cells with bare lithium and protected lithium with ionic liquid-based polymer at a current density of 0.5 mA cm⁻¹ for 4 h on the first cycle and later with 0.5 mA cm⁻¹ for 2 h.;

FIG. 3 represents SEM images of a) top-down view and b) cross-section of bare lithium surface; c) top-down view and d) cross-section of lithium surface covered with the polymeric protective composition;

FIG. 4 represents a schematic view of a lithium metal based electrochemical cell of the present disclosure;

FIG. 5 illustrates impedance spectroscopy measurements in symmetrical cells at OCV after 30 min and 1240 min.; and

FIG. 6 shows charge-discharge voltage profile for LFP assembled in the combination with bare lithium or protected by the polymer composition as negative electrodes.

### DETAILED DESCRIPTION

A practical example of a formulation for a polymeric protective composition according to the present disclosure will now be described.

All the components of the formulation are known from the prior art.

The deposition of the liquid solution can be carried out by different liquid solution deposition techniques on a solid surface (film applicator, soaking, etc.).

The polymerization of the liquid solution layer can be carried out by UV or heating.

The electrochemical cells according to the present disclosure can be manufactured according to known techniques. The use of this protected lithium anode can make it possible to use electrolytes that are not modified by the various types of additives mentioned above or simply to serve as electrolyte and separator at the same time.

The polymerizable ionic liquid, the cation or anion of which carries at least one polymerizable function, can have the following form (Table 1), as a non-limitative example according to a concentration between 50 wt. % and 70 wt. %, typically 60 wt. %.

TABLE 1
Example of different cations that carry at least one polymerizable
function and possible associated anions

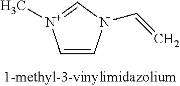

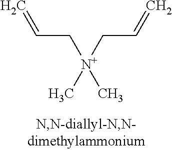

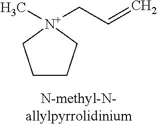

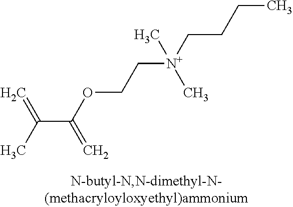

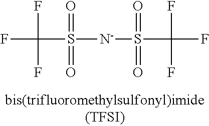 [SMILES: O=S(=O)([N-]S(=O)(=O)C(F)(F)F)C(F)(F)F]

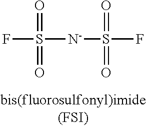

As exemplified in Table 1, different anions can be chosen from the group consisting of hexafluorophosphate (PF₆⁻), perchlorate (CIO₄⁻), tetrafluoroborate (BF₄⁻), hexafluoroarsenate (AsF₆⁻), trifluoromethanesulfonate (CF₃SO₃⁻), bis(trifluoromethanesulfonyl)imide (known by the abbreviation TFSI) N[SO₂CF₃]₂⁻, bis(fluorosulfonyl)imide (known by the abbreviation FSI) LiN[SO₂F]₂⁻, bis(pentafluoroethanesulfonyl)imide, N(C₂F₅SO₂⁻)₂⁻ (known by the abbreviation BETI), 4,5-dicyano-2-(trifluoromethyl)imidazolide (known by the abbreviation TDI) and mixtures thereof, with preference being given to LiTFSI, LiFSI and LiTDI.

Other examples may include other types of cation such as imidazolium, pyrrolidinium, ammonium, pyridinium, pyridazinium, pyrimidinium, pyrazinium, pyrazolium, thiazolium, oxazolium, triazolium, phosphonium, sulfonium. Some of such cations are illustrated below:

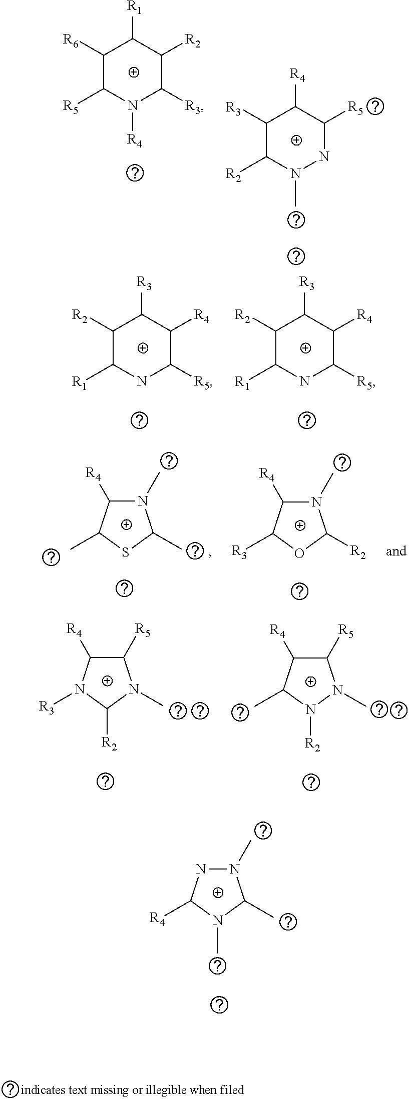

The non-polymerizable ionic liquid may have the following form, as a non-limitative example according to a concentration between 30 wt. % and 50 wt. %, typically 40 wt. %.

TABLE 2
Example of different cations and anions that are associated to get
non-polymerizable ionic liquids

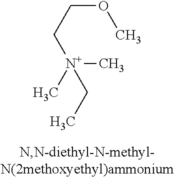

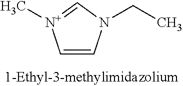

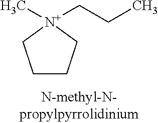

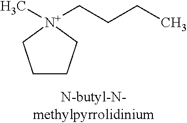

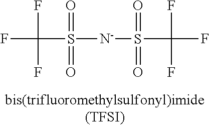 [SMILES: O=S(=O)([N-]S(=O)(=O)C(F)(F)F)C(F)(F)F]

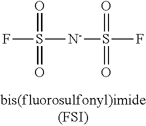

Other examples may include other types of cation such as imidazolium, pyrrolidinium, ammonium, pyridinium, pyridazinium, pyrimidinium, pyrazinium, pyrazolium, thiazolium, oxazolium, triazolium, phosphonium, sulfonium. As exemplified in Table 2, different anions can be chosen from the group consisting of hexafluorophosphate (PF₆), perchlorate (CIO₄⁻), tetrafluoroborate (BF₄⁻), hexafluoroarsenate (AsF₆⁻), trifluoromethanesulfonate (CF₃SO₃⁻), bis(trifluoromethanesulfonyl)imide (known by the abbreviation TFSI) N[SO₂CF₃]₂⁻, bis(fluorosulfonyl)imide (known by the abbreviation FSI) LiN[SO₂F]₂⁻, bis(pentafluoroethanesulfonyl)imide, N(C₂F₅SO₂)₂⁻ (known by the abbreviation BETI), 4,5-dicyano-2-(trifluoromethyl)imidazolide (known by the abbreviation TDI) and mixtures thereof, with preference being given to LiTFSI, LiFSI and LiTDI.

The ionic liquid of “crosslinker” type, the cation of which carries at least two polymerizable functions, can have the following form, as a non-limitative example according to a concentration between 1 mol. % and 5 mol. %, typically 3 mol. %, versus the polymerizable ionic liquid: 1,4-butanediyl-3,3′-bis-1-vinylimidazolium cation:

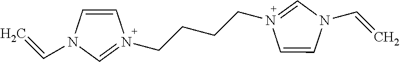

The lithium salt may be chosen from the group consisting of hexafluorophosphate (PF₆⁻), perchlorate (CIO₄⁻), tetrafluoroborate (BF₄⁻), hexafluoroarsenate (AsF₆⁻), trifluoromethanesulfonate (CF₃SO₃⁻), lithium bis(trifluoromethanesulfonyl)imide (known by the abbreviation LiTFSI) LiN[SO₂CF₃]₂, lithium bis(fluorosulfonyl)imide (known by the abbreviation LiF SI) LiN[SO₂F]₂, lithium bis(pentafluoroethanesulfonyl)imide LiN(C₂F₅SO₂)₂ (known by the abbreviation LiBETI), lithium 4,5-dicyano-2-(trifluoromethyl)imidazole (known by the abbreviation LiTDI) and mixtures thereof, with preference being given to LiTFSI, LiFSI and LiTDI.

The lithium salt may be present in the composition in a molar ratio ranging as a non-limitative example from 1:9 molar ratio to 2:3 molar ratio vs the non-polymerizable ionic liquid.

The ionic polymer included in the polymer composition according to the present disclosure may have the following form, as a non-limitative example according to a concentration between 1 wt. % and 5 wt. % versus the polymerizable ionic liquid: poly(diallyldimethylammonium bis (trifluoromethylsulfonyl)imide), or poly(diallyldimethylammonium bis (fluorosulfonyl)imide), as shown below:

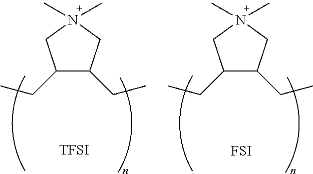

The polymerization initiator may be chosen from the following materials or compositions: Phenylbis(2,4,6-trimethylbenzoyl)phosphine oxide is given as an example that as successfully been used, according to a concentration between 1 mol. % and 5 mol. % versus the polymerizable ionic liquid

Example of a Membrane Preparation:

The polymeric composition based on ionic liquids was prepared inside an argon filled glove box. To a mixture of 40 wt. % of non-polymerizable ionic liquid N,N-diethyl-N-methyl-N-(2-methoxyethyl)ammonium bis(trifluoromethylsulfonyl)imide (DEMETFSI) and 60 wt. % of a polymerizable ionic liquid 1-ethyl-3-vinylimidazolium bis(trifluoromethylsulfonyl)imide (EVIMTFSI) was added an ionic liquid of “crosslinker” type 1,4-butanediyl-3,3′-bis-1-vinylimidazolium di-bis(trifluoromethylsulfonyl)imide (BVIMTFSI) in 3 mol % vs. EVIMTFSI. After all the components are dissolved, lithium bis(trifluoromethylsulfonyl)imide (LiTFSI) is added in 1:9 mol. ratio vs. DEMETFSI. At the end, poly(diallyldimethylammonium bis(trifluoromethylsulfonyl)imide) (polyDDATFSI) is added in 2 wt. % vs. EVIMTFSI. For the cross-linked polymerization of the polymeric ionic liquid mixture, the UV curing agent phenyl bis (2,4,6-trimethylbenzoyl) phosphine oxide was added in a 3.5 wt % vs. EVIMTFSI.

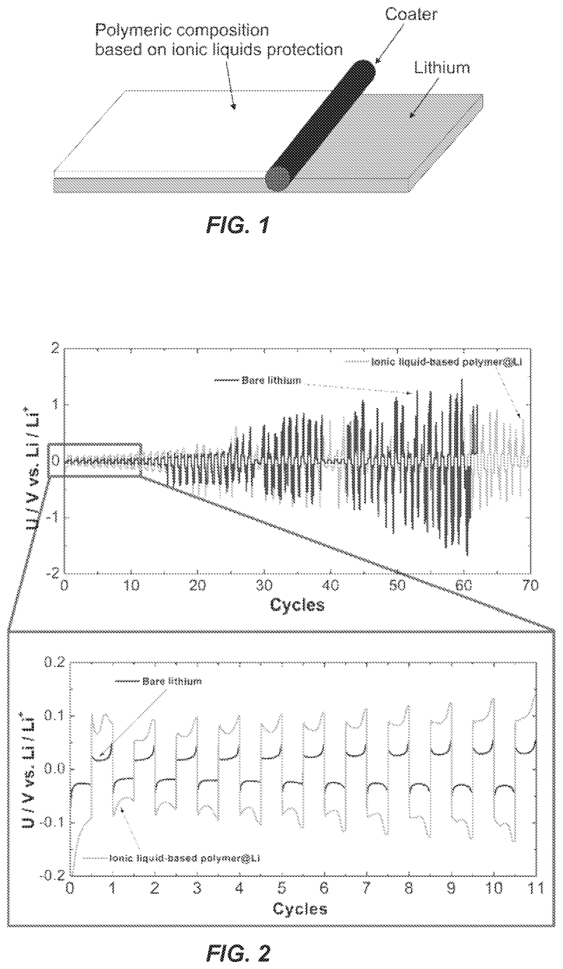

After all the components are dissolved forming a liquid viscous slurry, metallic lithium may be covered with such formulation using a doctor blade with a height between 10-250 μm inside an Ar filled glove-box at room temperature (FIG. 1). The lithium covered with such formulation was exposed to UV light for 5 min forming a cross-linked polymerized protected layer on the lithium surface. The prepared protection was tested in a symmetrical two electrode pouch cell. Stripping and deposition cycles were done at 0.5 mA/cm² for 4 hours on the first cycle and 0.5 mA/cm² for 2 hours for the rest of the cycles. In all the experiments, electrodes of 2 cm² of area were used.

FIG. 2 represents cycling for symmetrical cells of a bare and a protected lithium surface with the ionic liquid-based polymer protecting layer. The shape and the way the peaks evolve with cycling are different for both surfaces. For both surfaces, the over-potential of the cell is increasing with cycling. After 15 cycles, some sharp peaks associated with HSAL formation and short-circuits appeared. The bare lithium surface after the 25th cycle go in short-circuits and after that, the cycling ends for potential for the next cycles. For the protected Li with the polymeric composition based on ionic liquids, the cycling is never ending for potential cut-off, since never reaches the potential limit, even after 70 cycles the cell is working. It was observed that the coating does not avoid completely formation of dendrites, but can retard the short-circuits induced for it.

Membrane Homogeneity and Thickness

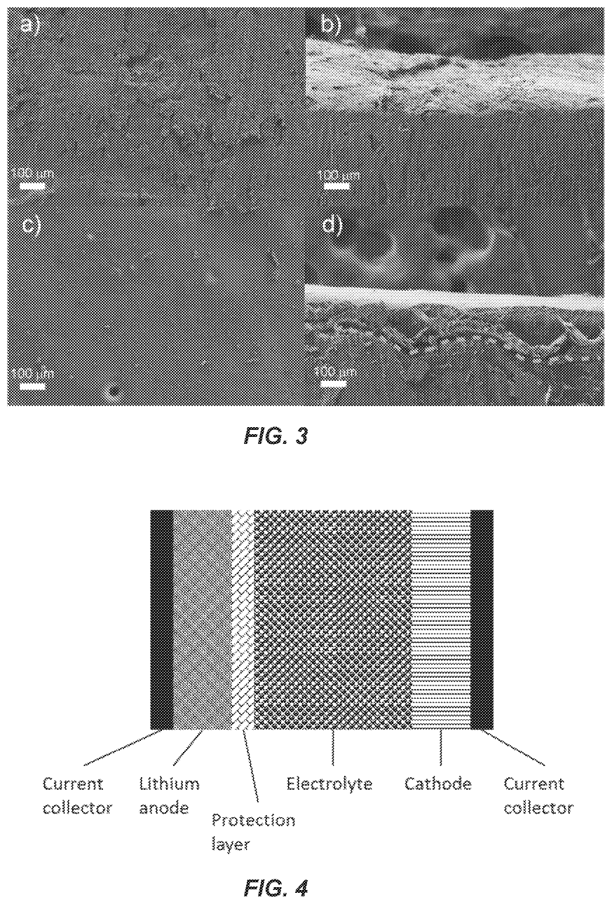

The polymeric protective composition was characterized with a field-emission scanning electron microscopy (FE SEM) Supra 35 VP (Zeiss, Germany). Samples were prepared and attached to a custom-made vacuum transfer holder in argon-filled glovebox, which is opened in the SEM chamber under reduced pressure. SEM images of bare lithium surface and lithium surface covered with the polymeric protective composition are shown in FIG. 3.

The bare lithium surface is rough and non-uniform (3a, b). When polymeric protective composition is applied on the Li surface (3c, d) this uneven surface is covered with a smooth, compact and very homogenous layer with some pinholes due to a direct polymerization on the lithium surface. On the cross-section view (3d), it can be observed that the polymeric protective composition is well adhered to the lithium surface. An estimated thickness of 60 μm was determined.

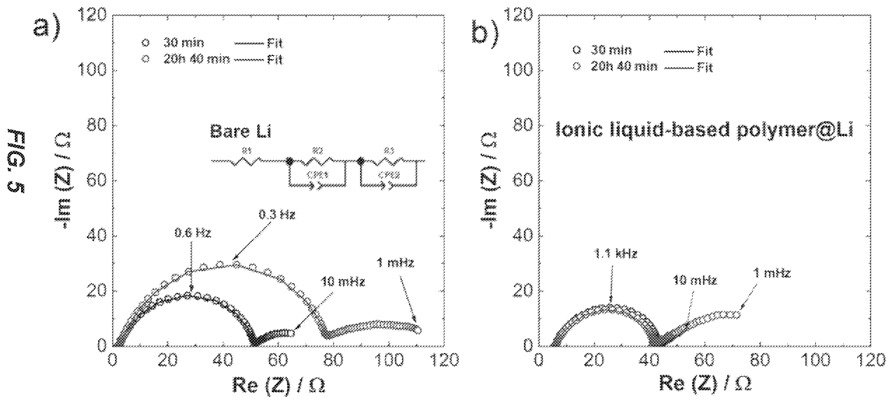

The ionic liquid-based composition according to the present disclosure is applied to one of the two faces of a lithium sheet, by deposition techniques known to those skilled in the art (example: doctor blade coater, such as reference K Control Coater from RK Print, Figure page 14). Then the polymerization is performed, resulting in a protective film of lithium. When mounting the battery, the protected side of lithium faces the second electrode (cathode), as shown in FIG. 4.

Conductivity of the Polymeric Protective Composition

For determination of ionic conductivity, a self-standing polymeric protective composition membrane with a thickness of 87 μm and a surface of 0.78 cm² was sandwiched between two copper foils. Nyquist plots were obtained at different temperatures. The ionic conductivity (σ) values where obtained from the impedance measurements using the formula: σ=t/(S·R), where t and S are the thickness and surface area of the membrane, respectively, and R is the ohmic resistance. The obtained ionic conductivity is 3.6×10⁻² mS.cm⁻¹ at room temperature and 4.9×10⁻¹ mS.cm⁻¹ at 80° C.

Stability and Compatibility of the Protective Polymer Composition with Lithium Metal

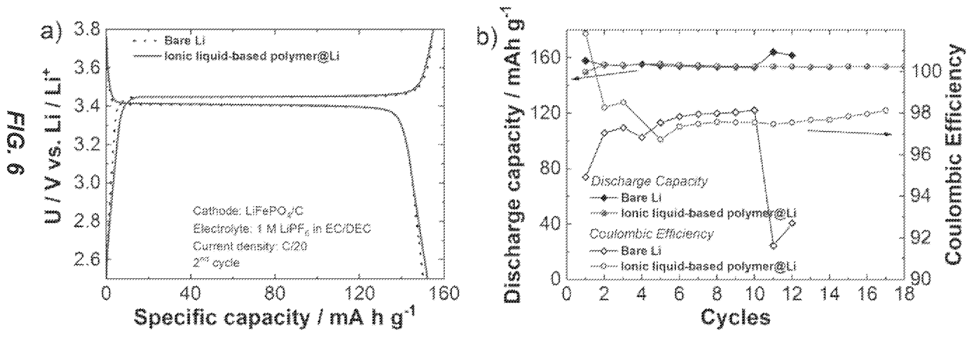

Stability and compatibility of ionic liquid-based polymer membrane with metallic Li was measured by impedance spectroscopy in the symmetrical cells at OCV after 30 min and 1240 min. Measured spectra shown in FIG. 5 were fitted with the equivalent circuit shown in the insert image. For this circuit R1 corresponds to the electrolyte resistance and the sum of R2 and R3 to the resistance of the lithium surface: resistance to the charge transfer and resistance of the SEI at the lithium electrodes.

For bare lithium, the sum of R2 and R3 increases from 49Ω for the cell after 30 min to 76Ω after 1240 min after the assembly. This increment of 55% is related to the formation of the SEI layer, due to the exposure of metallic lithium surface to the electrolyte when the cell is stored at OCV. In contrast, the resistance of Li-symmetrical cell with ionic liquid-based polymer@Li changes from 37Ω for 30 min to 35Ω after 1240 min after the assembly.

The membrane protects the metal surface from the continuous consumption of the electrolyte, thus preventing the growth of the SEI over time when the cell is stored at OCV. In consequence, impedance is almost not changing during the measurement. Once that lithium surface is covered with the protective ionic liquid-based polymer membrane, the growth of passive film is not as fast as in the case of the bare lithium surface.

Charging and Discharging Profile of a Complete Cell

FIG. 6 shows charge-discharge voltage profile for LFP assembled in the combination with bare lithium or protected by the polymer composition as negative electrodes. The cathode is made of LFP and the anode is made of lithium metal and coated with the protective polymer composition.

There is a small difference in the voltage profile, but the capacity is almost identical. The evolution of voltage at the beginning of the half-cycle (charge or discharge) is slower for the cell with lithium protected by the polymer composition as anode than for one with bare Li and, in consequence, the cell LFP/Li-protected needs more time to reach the plateau of voltage. These can be attributed to the effect caused for the retarding mass transport that was discussed previously for the lithium protected by the polymer composition samples. Nevertheless, it seems this has not negative effect on the cycling of a full cell with LFP as cathode at room temperature using low current densities. Both, charge and discharge profiles as also cell capacity (155 mAh g⁻¹) are almost the same for the both cell independent of negative electrode selection in this study. However, with the lithium protected by the polymer composition as negative electrode, more stable cycling is obtained with better coulombic efficiency.

Of course, the present disclosure is not limited to the embodiments that have just been described and many other embodiments of a polymer composition according to the present disclosure can be envisaged. In particular, it is possible to provide in this composition several polymerizable ionic liquids, whose cation or anion carries at least one polymerizable function, a plurality of non-polymerizable ionic liquids, several ionic liquids of “crosslinker” type, the cation or the anion of which carries at least two polymerizable functions, several lithium salts and several ionic polymers.

### REFERENCES

1. Peled, E. The electrochemical behavior of alkali and alkaline earth metals in nonaqueous battery systems—the solid electrolyte interphase model. J. Electrochem. Soc. 126, 2047-2051 (1979).
2. Aurbach, D. Review of selected electrode-solution interactions which determine the performance of Li and Li ion batteries. J. Power Sources 89, 206-218 (2000).
Cohen, Y. S., Cohen, Y. & Aurbach, D. Micromorphological studies of lithium electrodes in alkyl carbonate solutions using in situ atomic force microscopy. J. Phys. Chem. B 104, 12282-12291 (2000).

1. An ionic liquid-based composition for protecting a lithium metal part, comprising:
a polymerizable ionic liquid or ionic liquid monomer, the cation or the anion of which carries at least one polymerizable, function;
a non-polymerizable ionic liquid;
an ionic liquid crosslinker, the cation or the anion of which carries at least two polymerizable, functions;
a lithium salt; and
an ionic polymer.

2. The ionic liquid-based composition according to claim 1, wherein the polymerizable ionic liquid or ionic liquid monomer having a cation and/or anion carries at least one polymerizable, function has the following form, with R₁, R₂, R₃ and R₄ being a polymerizable chemical functionality:

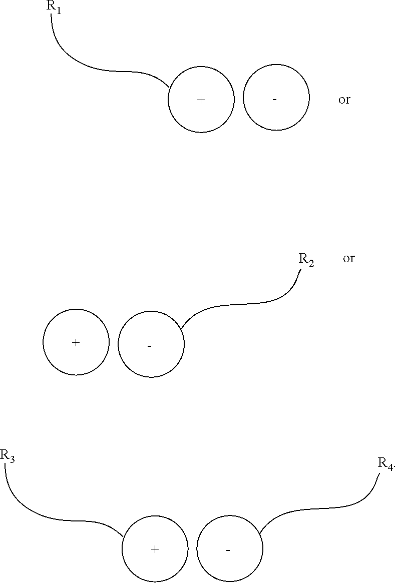

3. The ionic liquid-based composition according to claim 2, wherein the non-polymerizable ionic liquid has the following form and has cations and anions that do not carry any polymerizable chemical functionality:

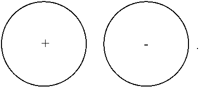

4. The ionic liquid-based composition according to claim 3, wherein the ionic liquid crosslinker having a cation or anion carrying at least two polymerizable functions has the following form, with R₅, R₆, R₇ and R₈ being a polymerizable chemical functionality:

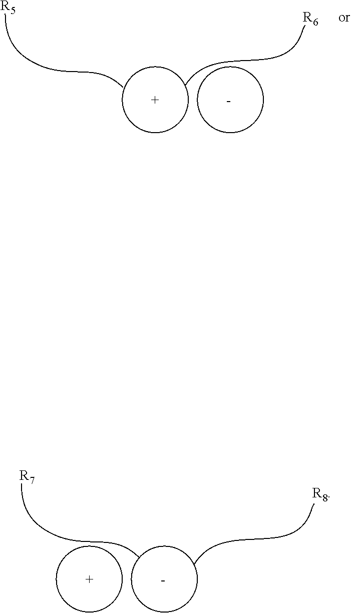

5. The ionic liquid-based composition according to claim 4, wherein the lithium salt is chosen from the salts of the following form:

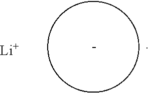

6. The ionic liquid-based composition according to claim 5, wherein the ionic polymer is chosen from polymers of the following form, with n and m being the number of repeating monomer units:

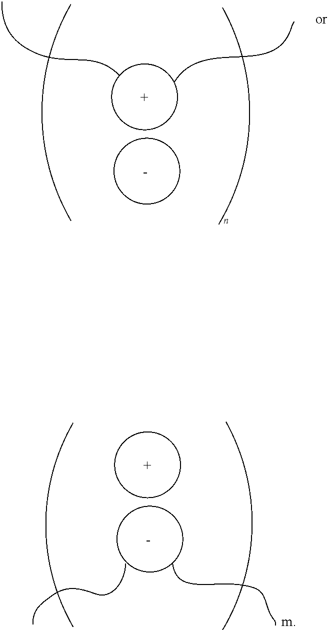

7. The ionic liquid-based composition according to claim 1, further comprising a UV or thermal polymerization initiator.

8. A method for coating a lithium metal part, implementing a protective polymer composition obtained by deposition and polymerization of a liquid formulation according to claim 1, comprising the steps of:
depositing a liquid solution having the composition on the metal part; and
polymerizing the deposited liquid solution.

9. The coating method according to claim 8, wherein the deposition step comprises applying the liquid solution to one of two faces of a lithium sheet, and wherein the polymerization step results in a protective film.

10. The coating method according to claim 8, wherein the deposition step comprises dipping a lithium sheet in the liquid solution.

11. An electrochemical lithium-based storage device, comprising a lithium anode coated with a polymer composition according to claim 1, the lithium anode facing a cathode.

12. The ionic liquid-based composition according to claim 1, wherein the non-polymerizable ionic liquid has the following form and has cations and anions that do not carry any polymerizable chemical functionality:

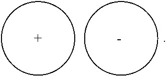

13. The ionic liquid-based composition according to claim 1, wherein the ionic liquid crosslinker having a cation or anion carrying at least two polymerizable functions has the following form, with R₅, R₆, R₇ and R₈ being a polymerizable chemical functionality:

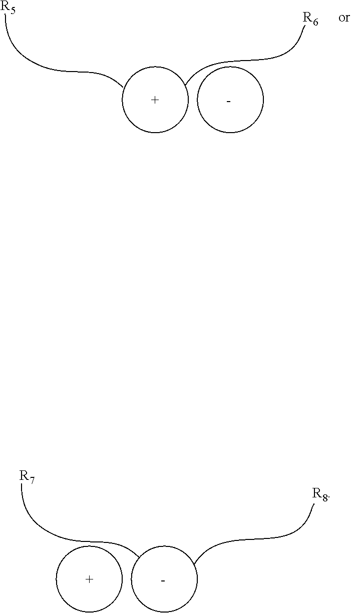

14. The ionic liquid-based composition according to claim 1, wherein the lithium salt is chosen from the salts of the following form:

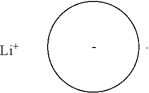

15. The ionic liquid-based composition according to claim 1, wherein the ionic polymer is chosen from polymers of the following form, with n and m being the number of repeating monomer units: [chemical structure]
